(19) United States
(12) Patent Application Publication
(10) Pub. No.: US 2025/0005506 A1
(43) Pub. Date: Jan. 2, 2025

(54) Systems and Methods for Training Large Language Models for Generating Accurate Shipping Forecasts

(71) Applicant: Galleon Technology, Inc., Los Angeles, CA (US)

(72) Inventors: Ben Fowlersmith, Los Angeles, CA (US); Sam Luu, Los Angeles, CA (US); Scott Frazier, Los Angeles, CA (US)

(73) Assignee: Galleon Technology, Inc., Los Angeles, CA (US)

(21) Appl. No.: 18/761,087

(22) Filed: Jul. 1, 2024

Related U.S. Application Data
(60) Provisional application No. 63/511,153, filed on Jun. 29, 2023.

(51) Int. Cl. G06Q 10/0835; G06N 3/0895; G06Q 10/083

(52) U.S. Cl. CPC G06Q 10/0835; G06N 3/0895; G06Q 10/0838

(57) ABSTRACT

Systems and methods for training a large language model to generate accurate shipping forecasts in accordance with embodiments of the invention are illustrated. One embodiment includes a method for training a large language model to generate accurate shipping forecasts. The method includes receiving input data that includes a plurality of categories of shipment data, wherein the shipment data includes a shipment progress date sequence, standardizing each of the plurality of categories of shipment data, generating a plurality of shipping profiles based on the standardized shipment data, and training a large language model to generate a new shipping profile, wherein the new shipping profile includes a predicted shipment progress date sequence associated with an upcoming shipment.

### CROSS-REFERENCE TO RELATED APPLICATIONS

The current application claims the benefit of and priority under 35 U.S.C. § 119(e) to U.S. Provisional Patent Application No. 63/511,153 entitled “Systems and Methods for Training Large Language Models for Generating Accurate Shipping Forecasts” filed Jun. 29, 2023. The disclosure of U.S. Provisional Patent Application No. 63/511,153 is hereby incorporated by reference in its entirety for all purposes.

### FIELD OF THE INVENTION

The present invention generally relates to machine learning and, more specifically, training large language models to generate forecasts for shipping logistics.

### BACKGROUND

Shipping logistics involves the planning, execution, and management of the transportation of goods from one point to another. It encompasses various stages such as inventory management, warehousing, packaging, and transportation. Effective shipping logistics ensures that goods are delivered to the right place at the right time in the most cost-effective and efficient manner. It also involves dealing with various influential variables and external factors that can impact the shipment process, such as weather conditions, geopolitical events, and industry trends. accurate shipment forecasts are essential for businesses to operate smoothly and efficiently in the freight management industry.

Machine learning (ML) is a subset of artificial intelligence (AI) that focuses on developing algorithms and statistical models that enable computers to perform specific tasks without explicit instructions. It relies on patterns and inference derived from data. Machine learning algorithms build models based on sample data, known as training data, to make predictions or decisions without being explicitly programmed to perform the task. Large language models (LLMs) are a specific type of machine learning model designed to understand and generate human-like text based on vast amounts of textual data. These models, such as OpenAl's GPT-4, are typically built using neural network architectures, especially transformers, which enable them to handle complex language patterns and context. LLMs are trained on diverse datasets encompassing books, articles, websites, and other text sources, allowing them to generate coherent and contextually relevant responses in natural language. Their applications range from automated customer support and content creation to advanced research tools and language translation services.

### SUMMARY OF INVENTION

Systems and methods for training a large language model to generate accurate shipping forecasts in accordance with embodiments of the invention are illustrated. One embodiment includes a method for training a large language model to generate accurate shipping forecasts. The method includes receiving input data that includes a plurality of categories of shipment data, wherein the shipment data includes a shipment progress date sequence, standardizing each of the plurality of categories of shipment data, generating a plurality of shipping profiles based on the standardized shipment data, and training a large language model to generate a new shipping profile, wherein the new shipping profile includes a predicted shipment progress date sequence associated with an upcoming shipment.

In a further embodiment, the plurality of categories of shipment data includes at least one source of shipment data selected from the group consisting of: freight logistic data, importer supply chain data, and external factor data.

In still another embodiment, the freight logistic data includes at least one source of freight logistic data selected from the group consisting of: vessel traffic data, vessel schedules, ocean carrier service itineraries, lists of actively registered International Maritime Organization (IMO) vessels, and ocean container vessel data.

In a still further embodiment, the external factor data includes at least one source of external factor data selected from the group consisting of: inclement weather conditions, port congestion conditions, and current market conditions.

In yet another embodiment, the importer supply chain data includes at least one source of importer supply chain data selected from the group consisting of: Packing Lists (PL), enterprise resource planning (ERP) systems, freight management software, manual data entries, and custom-house data.

In a yet further embodiment, the large language model is trained using a training corpus comprising a data frame built by combining freight logistic data, importer supply chain data, external factor data, and shipment outcomes.

In another additional embodiment, the input data includes Master Bill of Lading (MBL) numbers identifying a cargo booking.

In a further additional embodiment, input data is processed using optical character recognition to extract text from the input data.

In another embodiment again, the new shipping profile is adjusted by the large language model when the actual shipping progress deviates from the predicted shipping progress.

One embodiment includes a non-transitory machine readable medium containing processor instructions for training a large language model to generate accurate shipping forecasts, where execution of the instructions by a processor causes the processor to perform a process that includes receiving input data comprising a plurality of categories of shipment data, wherein the shipment data includes a shipment progress date sequence, standardizing each of the plurality of categories of shipment data, generating a plurality of shipping profiles based on the standardized shipment data. and training a large language model to generate a new shipping profile, wherein the new shipping profile includes a predicted shipment progress date sequence associated with an upcoming shipment.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a system for training large language models for generating accurate shipping forecasts in accordance with an embodiment of the invention.

FIG. 2 illustrates a process for training large language models to generate accurate shipping forecasts in accordance with an embodiment of the invention.

FIG. 3 illustrates a process for generating accurate shipping forecasts using large language models in accordance with an embodiment of the invention.

FIG. 4 illustrates a data server that executes instructions to perform processes that provide data for the training of large language models for generating shipping forecasts in accordance with an embodiment of the invention.

FIG. 5 illustrates a forecast server that executes instructions to perform processes that generate accurate shipping forecasts in accordance with an embodiment of the invention.

FIG. 6 illustrates a forecast application for generating forecasts in accordance with an embodiment of the invention.

FIGS. 7A-B illustrate a generated shipping forecast in accordance with an embodiment of the invention.

FIG. 8 illustrates a user interface for generating shipping forecasts in accordance with an embodiment of the invention.

### DETAILED DESCRIPTION

Freight management can be very complex, given its multifaceted nature and numerous influential variables. Slight changes in one stage of freight shipment can cause chain reactions that can result in costly delays for all parties involved. Therefore, it is important for businesses to have accurate shipment forecasts in freight management such that they can operate smoothly. Large language models (LLMs) have been hailed for their transformative ability to generate expected words using correlations and associations. However, LLMs have typically not been able to be implemented in the context of freight management due to their inability to understand the shipping industry and the large amounts of data in freight management.

Systems and methods in accordance with embodiments of the invention can remedy the above issues by utilizing a data processing pipeline that trains an LLM using historical shipping data that is preprocessed to impose structure to the data that allows the LLM to learn patterns that enable the forecasting of the date on which a series of shipment progression milestones will occur (e.g. departure dates, and/or arrival dates). In many embodiments, data is structured into shipping profiles in which the profile defines multiple categories of data relevant to the shipment of goods. The dates associated with a set of shipment milestones for a shipment profile can be referred to as a shipment progress date sequence. In several embodiments, the predictive capabilities of generative models such as LLMs can be harnessed to make allowances for incomplete input data in a shipping profile for a new shipment. Furthermore, a generative model such as an LLM trained in accordance with various embodiments of the invention can generate multiple future forecasts for the shipment progress date sequence of a new shipping profile.

In many embodiments, training systems leverage datasets available from freight logistics tracking, importer supply chain planning, and real-time event monitoring to create structured data sets for the training of an LLM. In several embodiments, training data sets include multiple shipment profiles where each shipment profile includes information related to the shipment (e.g. origination, destination, shipper) and an associated shipment progress date sequence. In several embodiments, the system includes a data processing pipeline that creates the shipment profiles using techniques including (but not limited to) auto-labeling unstructured data and standardizing varied datasets.

In selected embodiments, the system also takes the broader contextual factors into account, thereby enhancing the sophistication and accuracy of freight shipping forecasts. In a number of embodiments, sources of data regarding external factors are utilized to attempt to quantify impacts from geopolitical, financial, and industry. In many embodiments, the sources of data utilized to assess external factors include (but are not limited to) news headlines, weather alerts, and/or trade indices. This data can provide a broader context that enhances the ability of an LLM to learn the relationship between external factors and the shipment progress date sequences associated with specific shipping profiles. In certain embodiments, an additional dedicated data pipeline can be utilized that incorporates both standardized shipment profiles and external factor vector embedding outputs to create a vector-enhanced standardized shipment model that can then be utilized both in the training of an LLM and in the generation of shipping profiles and shipment progress date sequences.

In several embodiments, as the shipment progresses and new events occur (e.g. a Port of Loading Departure and/or a change in an external factor such as weather), the new event data can be integrated into the shipping profile for the shipment and the generative model can be used to generate a new forecast of the associated shipment progress date sequence. In the event that the new forecast diverges from the original forecast, the system can flag the potential issue to a user using any of a variety of user interfaces and/or notification mechanisms. In a number of embodiments, the generative model can also be utilized to identify modifications that can be made to the shipping plan (e.g. change downstream shippers) to minimize the likelihood of delays. In several embodiments, changes in forecasts can be efficiently visually represented through the use of a user interface that displays each leg of a shipment and uses a color coding and/or health score to represent the leg of the shipment that is likely to be associated with a delay in a forecast arrival date of the shipment at its ultimate destination.

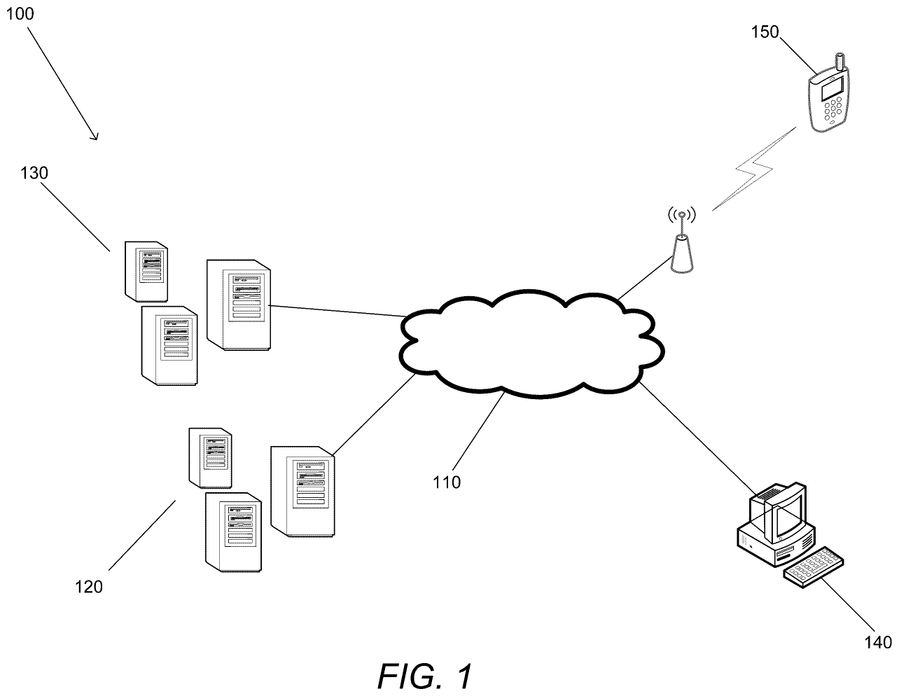

A system for training large language models for generating accurate shipping forecasts in accordance with an embodiment of the invention is conceptually illustrated in FIG. 1. In many embodiments, system 100 includes a communication network 110. The communication network 110 may be a network such as the Internet that allows devices connected to the network 110 to communicate with other connected devices. In numerous embodiments, system 100 includes a large language model (LLM) deployed on forecast server system 120. System 100 can include a data server system 130. In many embodiments, the forecast server system 120 receives a plurality of categories of shipping-related data of various carriers from the data server system 130. The forecast server system 120 is able to standardize the categories of shipping-related data in a manner such that the LLM is able to ingest them.

The system 100 can also include a user device 140 and/or a mobile device 150. The user device 140 and/or mobile device 150 can be used to interact with the forecast server system 120 through the communication network 110. In many embodiments, the user device 140 and/or mobile device 150 can be used to interact with the data server 130 to obtain the appropriate data for generating shipping profiles that may be used to train the LLM in the forecast server system 120. One skilled in the art will recognize that a system for training LLMs to generate accurate shipping forecasts may exclude certain components and/or include other components that are omitted for brevity without departing from this invention.

In many embodiments, vector embeddings of the plurality of categories of data are extracted by the data server system and/or the forecast server system. The standardized data may be used by the forecast server system to generate shipping profiles and associated shipment progress date sequences for each shipment identified within the training data set. A generative model, such as (but not limited to) an LLM, can be trained on the shipping profiles and their associated shipment progress date sequences such that the model can learn (in an unsupervised manner) associations between the data within specific shipping profiles and the resulting shipment progress date sequences. In some embodiments, the forecast server system can utilize the trained model to take in an incomplete shipping profile as input and produce the most likely completed shipping profile and associated shipment progress date sequence. As can readily be appreciated, a variety of server systems can be utilized to ingest and structure data into shipping profiles and associated shipment progress date sequences, train a generative model using the shipping profiles and their associated shipment progress date sequences, and/or use the trained generative model to generate shipment progress date sequence forecasts for specific shipments. Accordingly, the specific server systems that are utilized within systems implemented in accordance with various embodiments of the invention are not limited to the server system described above. Processes for data acquisition, data processing, prediction, and risk calculation in accordance with various embodiments of the invention are discussed further below.

### Data Acquisition

Supply Chain Management can be a multifaceted web of variables, with each shipment potentially impacted by a myriad of different factors. To deal with this complexity, the system can parametrize each factor that could influence a shipment's journey, resulting in a comprehensive approach to managing freight logistics.

Processes for data compilation in accordance with many embodiments of the invention involve extracting publicly available data from various ocean monitoring sources across specific travel routes. These shipping and freight data can include (but is not limited to) vital details such as ship itineraries, current vessel locations, weather conditions, tracking information, and a plethora of other maritime details. In many embodiments, publicly available data from ocean freight carrier services, including but not limited to Maersk and MSC, is used to analyze and extract trends and patterns to train LLMs. Vessel traffic data services, including but not limited to Marine Traffic and VesselFinder, can be used to train LLMs. In several embodiments, weather data such as OpenWeatherMap, port terminal capacity, and chassis usage from USDoT FLOW may also be used to train the model. Further, headlines specific to market conditions aggregated from freight news publications, including but not limited to Freightwave, Loadstar, and Alphaliner, can be used to supplement the analysis of data for model training.

In some embodiments, vessel schedules sourced from ocean carrier tracking websites are used in the training of LLMs. For example, vessel schedules with respect to time from initial booking through actual vessel arrival may be used as a means to provide more context of shipping schedules to train LLMs. Ocean carrier service itinerary and lists of actively registered International Maritime Organization (IMO) vessels and port calls may also be obtained to train LLMs. In a number of embodiments, training systems obtain data of ocean container vessels from Automatic Identification System (AIS) data provided by global vessel traffic service (VTS), which can be used to train LLMs. Ocean container vessel data in accordance with selected embodiments includes vessels' speed, draft, and geographical positions. In some embodiments, ocean container vessel data also includes inclement wind speeds and precipitation conditions along vessel routes, as well as a congestion measure of terminal (e.g. reported in twenty-foot equivalent unit (TEU) volume and capacity).

The obtained shipping and freight data, combined with historical records, can allow systems in accordance with several embodiments of the invention to generate a comprehensive set of profiles matched across time periods, providing deeper insights into how different data elements correlate and influence each other.

In several embodiments, the system organizes data that influences freight shipments into three distinct categories: freight logistics, importer supply chain, and external factors. Each category can serve a separate purpose and can contribute to creating a holistic picture of shipping logistics.

In many embodiments, the freight logistics category encapsulates data sourced from shipping websites, APIs, and other tracking services, detailing bills of lading (BOL), voyage specifics, visited ports, vessel capacity, and other related aspects.

In certain embodiments, the importer supply chain data category is used to enhance cargo visibility during transit and includes details sourced from Packing Lists (PL), enterprise resource planning (ERP) systems, freight management software, manual data entries, and custom-house data. It represents the importers' processes and logistics setup that we aim to streamline.

In many embodiments, the external factors data category captures data related to changes in weather, geopolitical developments, and financial indices from sources such as new feeds, including Twitter, freightwaves, alpha liner, and marine traffic API services. This data identifies potential impacts on maritime operations, facilitating predictive adjustments in logistical decisions.

The amalgamation of these three data types can provide a detailed understanding of travel routes, vessel locations, carrier schedules, and other maritime operations. This comprehensive data set can enhance strategic planning, help in predicting potential disruptions due to unforeseen circumstances, and enable efficient logistical operations management, and/or facilitate timely delivery.

In a number of embodiments, the expansive data acquisition process that is employed by the system provides stakeholders with accurate, data-driven insights that enable informed decision-making with a direct impact on their operations. The systematic compilation, categorization, and analysis of this data form a rich resource that can be leveraged by generative models including (but not limited to) LLMs to enable forecasting and assist users with navigating the complexities of global shipping logistics effectively.

Systems in accordance with a number of embodiments of the invention use historical data, including (but not limited to) shipping records, shipment patterns, routes, delivery timings, and potential disruptions. This historical data can be utilized by LLMs to extract valuable insights regarding repeatable trends. These trends can guide the forecasts generated by the LLM to provide more accurate forecasts. In contrast, real-time data provides the most current information about ongoing shipments. This data is helpful for updating risk assessments and delivery expectations.

During the training of the generative models employed in many embodiments of the invention, equal importance can be provided to both historical and real-time data, in order to promote consistency and accuracy. Once training is complete, the model can utilize real-time data and apply the patterns learned from historical data, enabling forecasts that maintain a high degree of accuracy.

### Data Processing

The data processing employed by systems in accordance with many embodiments of the invention can involve the standardization and in-depth analysis of collected data. This process can allow the system to identify patterns and trends intrinsic to the maritime shipping industry, which are instrumental in enhancing the reliability of freight shipment forecasts generated by the model. With the help of a dedicated data pipeline, real-time data and quantified impacts can be ingested, applying recency bias to a condensed output as vector embeddings to simplify the complexity of data inputs.

As part of the data processes, systems in accordance with many embodiments of the invention can create an initial comprehensive shipping profile that can include (but is not limited to including) information about the shipper's supply chain profile and individual shipment data. In several embodiments, the shipping profile includes shipment data regarding significant factors such as (but not limited to) the shipper, carrier, vessel, voyage, ports of call, delivery address, location and/or any additional data that may be relevant to the progress of a shipment. In several embodiments, the shipping profile can be enriched with operational milestone data garnered from freight logistics tracking, providing a standardized shipment model.

### Auto-Labeling Complex Data (Data Gathering Pipeline)

Systems in accordance with many embodiments of the invention incorporate a data collection pipeline, which uses an automatic labeling method to process incoming data and convert it into a shipping profile (similar to an embedding) based upon a format that can be easily processed by the system during the subsequent training of a generative model such as (but not limited to) an LLM. One way we do this is by using Master Bill of Lading (MBL) numbers-which function as a unique identifier for a cargo booking with a maritime carrier to gather shipment details. In several embodiments, the process takes a set of raw data and outputs an array of profile information and temporal details, with any level of completeness. This same process can also generate data that aligns with historical or desired outputs.

In numerous embodiments, data collection pipelines process raw input data using an applied function to produce a set of desired outputs. Input data may include Master Bills, purchase orders, and/or commercial invoices that describe a plurality of past shipments.

Data collection pipelines in accordance with several embodiments can use supply chain information associated with a customer and freight logistic information associated with a carrier to further supplement the input to generate output shipment information with the desired completeness. Supply chain information may include the customer's supplier network, partner network, and/or distribution network. Freight logistic information may include the carrier's shipping routes and schedules, vessel positions and speeds, historical service schedules, and/or historical vessel routes. In selected embodiments, data collection pipelines use external information such as inclement weather conditions, port congestion conditions, and/or current market conditions as additional inputs in the generation of outputs.

Outputs in accordance with many embodiments include an expected shipping commencement, an expected service milestone completion date, an expected ocean vessel itinerary, an expected final delivery date, and a risk measure. The risk measure can refer to the probability of service commitment for a particular carrier.

Training data for the applied function may be obtained from historical records acquired through manual Master Bill lookup to actual shipment commencement, milestone dates, and delivery dates from carrier websites, importer ERP systems, and/or importer delivery orders. Input data in accordance with many embodiments is used with the applied function to retrieve shipping routes and vessel schedule details from the carrier website. Additional current conditions may be obtained from the vessel's itinerary, including weather, port congestion, and/or recent freight headlines as augmented context. Additional inputs such as purchase orders and/or commercial invoices may be used to retrieve additional context from the importer's supply chain. In many embodiments, prompt details from past partner performance, such as supplier cargo readiness, delivery turnaround time, and/or distribution center availability, can be provided for training.

The resultant dataset can be utilized to train a Language Model (LLM), which can generate highly accurate predictive temporal outputs. This strategy proves to be more efficient and productive than other methods, such as Recurrent Neural Networks (RNNs), Hidden Markov Models (HMMs), or Autoregressive Integrated Moving Average's (ARIMA).

In a number of embodiments, the system has the ability to handle varying degrees of data completion. For instance, the inputs at this stage could consist of just the profile and any known dates, while the output covers all familiar dates or even potentially missing dates or profile fields. This iterative processing approach enables the model to map any given input, regardless of its completeness, to the historical output that aligns with specific shipments used in the training set. Consequently, the model can anticipate a full temporal output from a diverse set of shipment profile details, taking into account their known or unknown temporal specifics.

### Processing of External Factors

Systems in accordance with several embodiments of the invention can process data related to external factors by defining a system to quantify impacts from geopolitical, financial, and industry through the use of data sources including (but not limited to) news headlines, weather alerts, and trade indices. In several embodiments, this data can provide a broader context that enhances the model's forecast accuracy. In several embodiments, an additional dedicated data pipeline is utilized that incorporates both a standardized shipping profile and an external factor vector embedding to output a vector-enhanced standardized shipment model. This systematic and quantified data processing approach can allow the system to curate a dataset enriched with context-aware factors and precise shipment details. In this way, the dataset can be used to train either a Language-based Learning Model (LLM) or a probabilistic model that can then be utilized for generating reliable predictive outcomes.

In essence, the data processing stage can be key to shaping the raw, unstructured data into a valuable input resource that can be leveraged by the various types of models that can be utilized in accordance with different embodiments of the invention. In many ways, the structure of the data forms an important element of the system's ability to handle incomplete data sets and still produce highly accurate, context-aware predictions.

### Shipping Model AI Image Adapter

In several embodiments, the process of training a model, such as (but not limited to) an LLM, includes both (a) parsing and (b) inclusion of extraction instructions into a target dataset prepared for processing. The inclusion of extraction instructions can be used to accelerate preparation. The resultant text can then be used as source data for fine-tuning an Artificial Intelligence model, such as (but not limited to) GPT-based models. These models can tokenize the inputs into multi-dimensional vector coordinates that are used to map a particular input with the most likely output. The result of this is a deliberate shaping of how the model responds and produces results based on the input.

In many embodiments, training systems import input data used for the training of one or more LLMs. Input data may include Master Bills, commercial invoices and/or purchase orders. Optical character recognition (OCR) may be applied to input data to extract text from the input data. Once text is extracted from input data, training systems in accordance with certain embodiments process the text to generate semantic structure data representations for the input data that indicates the relationships between the various categories within the input data.

Training systems in accordance with several embodiments generate prompts that are used to train one or more LLMs. By leveraging historical shipment data, training systems can generate prompts to train the one or more LLMs accurately for shipment forecasts. In various embodiments, training systems create training prompts by first obtaining a description of an extracted output data structure. Outputs used for training may be obtained from completed historical shipments containing carrier and importer information, as well as external factor information. Training systems may obtain a description of an input data structure, including the text and semantic structure. In some embodiments, information on the importer, carrier, and external factors that are present in the input data structure may be augmented to facilitate training. Training systems in accordance with a number of embodiments can design task-specific prompts that take all contexts present in input and output data to train one or more LLMs for generating shipping forecasts.

In some embodiments, training systems include validation mechanisms to validate the data extracted for prompt generation. Training systems in accordance with selected embodiments include a human in the loop that can correct and refine extracted data to increase the accuracy of future prompt generation. In many embodiments, various categories of input data may be used to validate each other. Master Bill numbers can be used to look up data related to specific carriers. Training systems can then utilize booking and itinerary data to verify and validate carrier data. In some embodiments, training systems can use commercial invoice and purchase order data to look up supplier and shipment details and also importer data, which may be validated by data gathered from importer ERP.

### Prediction Model

Systems and methods in accordance with certain embodiments of the invention utilize a unique predictive model, leveraging the extraordinary embedding capabilities of Language-based Learning Models (LLMs). This model can predict unidentified events and dates in a shipment itinerary based on the dataset's wider context.

Initially, the model can generate a “typical timeline” for each specific shipment profile, which can be referred to as an estimated shipment progress date sequence. This timeline can take into account several factors like the shipper, carrier, vessel, voyage, and ports to create a standard shipment process. This standardization can provide a reliable baseline for predictions and allows the model to suggest a complete shipment model even when confronted with an incomplete shipment context.

As the shipment progresses through its lifecycle and reaches various milestones, the system can gather more context and feed it into the model. This iterative process can enable the model's predictions to converge on the remaining incomplete context, enhancing the accuracy of outcomes. In practice, once the system confirms a key event, such as a Port Of Loading Departure, this data can be integrated into the shipment profile and the model used to estimate the remaining uncertain dates within the shipment progress date sequence.

In a number of embodiments, this process enables each new piece of data to be used to refine the shipment progress date sequence continuously, thereby improving the accuracy of the estimated delivery date and providing a more detailed insight into the shipment's journey. Additionally, the current output of external factor vector embeddings can be fed into the shipping profile, incorporating real-time industry context. This information can be crucial in predicting potential disruptions due to factors like weather conditions, geopolitical developments, and industry trends, further enhancing our model's predictive accuracy.

### Risk Calculation

In several embodiments, the system is capable of generating a comprehensive risk profile for each shipment based on the predicted shipment progress date sequence. In certain embodiments, the system evaluates multiple factors, including transit time, weather conditions, geopolitical influences, and possible interruptions, using them to calculate a risk score. The risk grading offers an ongoing real-time insight into the potential issues a shipment might face during its journey.

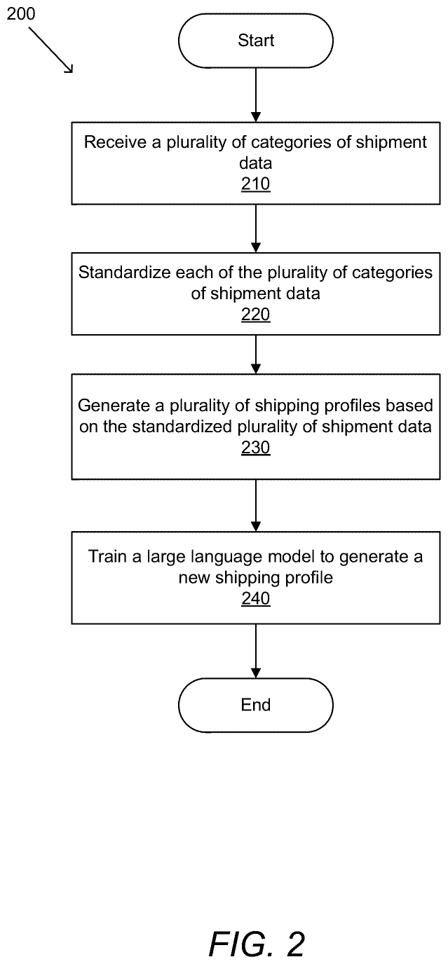

Referring again to the drawings, processes for ingesting data and training generative models and systems that can be utilized in the generation of forecasts in accordance with embodiments of the invention are illustrated in FIGS. 2-6. A process for training large language models to generate accurate shipping forecasts in accordance with an embodiment of the invention is illustrated in FIG. 2.

Process 200 receives (210) a plurality of categories of shipment data. In many embodiments, custom tools for various different carrier APIs and external data source APIs are created to obtain shipping-related data for prompting and training.

Process 200 standardizes (220) each of the plurality of categories of shipment data. Data preprocessors may be used to facilitate the standardization of shipment data to perform better feature extraction and provision.

Process 200 generates (230) a plurality of shipping profiles based on the standardized plurality of shipment data. Training corpora, in accordance with many embodiments, are built by combining customer profiles, carrier profiles, outputs from custom tools, and shipment outcomes into a data frame for each individual shipping profile within the plurality of shipping profiles.

A large language model in accordance with several embodiments is trained (240) to be able to generate a new shipping profile. New shipping profiles in accordance with many embodiments include a shipment progress date sequence for an upcoming shipment. In several embodiments, new datasets from active shipment bookings are continually added to the LLM training corpus and retrained on a monthly basis.

While specific processes for training large language models to generate accurate shipping forecasts are described above, any of a variety of processes can be utilized to train large language models as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

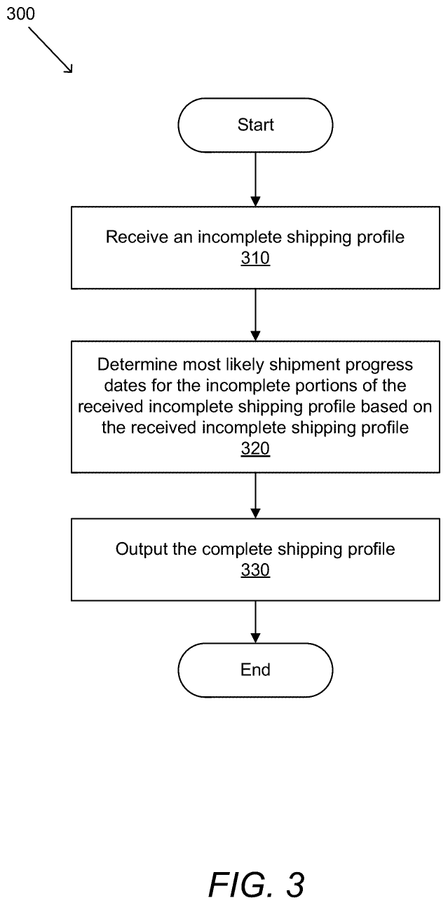

A process for generating accurate shipping forecasts using large language models in accordance with an embodiment of the invention is illustrated in FIG. 3. Process 300 receives (310) an incomplete shipping profile. Incomplete shipping profiles in accordance with many embodiments may be lacking in many important shipment-related information such as projected dates. Process 300 determines (320) a set of most likely shipment progress dates for the incomplete portions of the received incomplete shipping profile based on the received incomplete shipping profile. In numerous embodiments, LLMs trained for the purpose of generating shipping forecasts are used to determine the set of most likely shipment progress dates to populate the incomplete shipping profile.

Process 300 outputs (330) a complete shipping profile. Complete shipping profiles in accordance with many embodiments may be subject to further adjustments by the trained LLMs if the actual shipping progress deviates from the determined most likely shipping progress.

While specific processes for generating accurate shipping forecasts using large language models are described above, any of a variety of processes can be utilized to generate accurate shipping forecasts as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

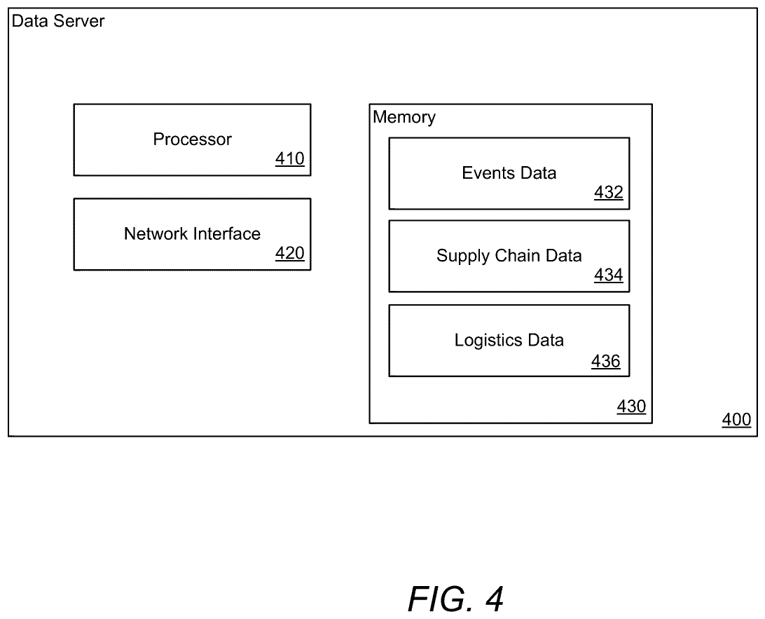

A data server that executes instructions to perform processes that provide data for the training of large language models for generating shipping forecasts in accordance with an embodiment of the invention is illustrated in FIG. 4. The data server 400 includes processor 410, network interface 420, and memory 430. One skilled in the art will recognize that a data server may exclude certain components and/or include other components that are omitted for brevity without departing from this invention.

The processor 410 can include (but is not limited to) a processor, microprocessor, controller, or a combination of processors, microprocessor, and/or controllers that performs instructions stored in the memory 430 to manipulate data stored in the memory. Processor instructions can configure the processor 410 to perform processes in accordance with certain embodiments of the invention. In various embodiments, processor instructions can be stored on a non-transitory machine readable medium.

Data server 400 can utilize network interface 420 to transmit and receive data over a network based upon the instructions performed by processor 410. Network interfaces in accordance with many embodiments of the invention can be used to gather inputs that can be used to generate shipping profiles. Memory 430 can include events data 432, supply chain data 434, and logistics data 436. In some embodiments, either events data, supply chain data, or logistics data alone, or a combination of events data, supply chain data, and logistics data is standardized and used to generate shipping profiles.

Although a specific example of a data server is illustrated in this figure, any of a variety of data servers can be utilized to perform processes for providing data for the training of large language models for generating shipping forecasts similar to those described herein as appropriate to the requirements of specific applications in accordance with embodiments of the invention.

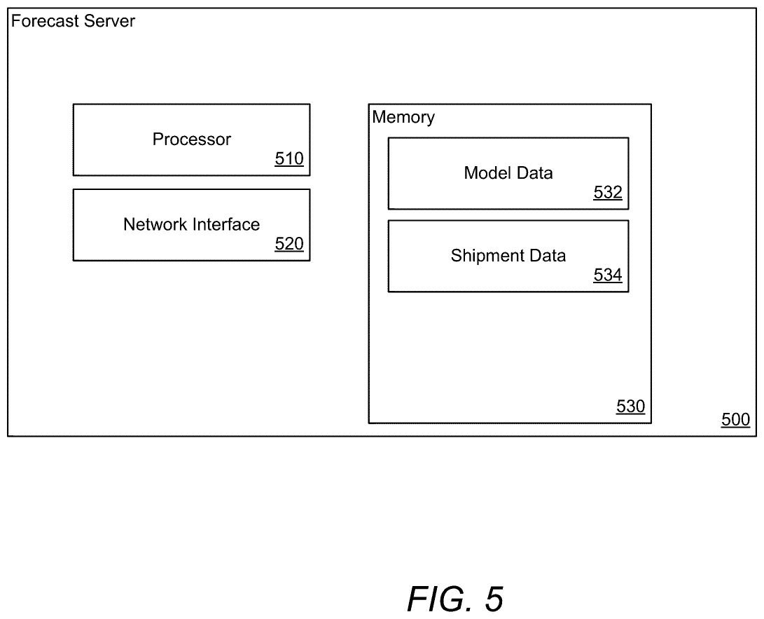

A forecast server that executes instructions to perform processes that generate accurate shipping forecasts in accordance with an embodiment of the invention is illustrated in FIG. 5. In many embodiments, the forecast server 500 includes processor 510, network interface 520, and memory 530. One skilled in the art will recognize that a forecast server may exclude certain components and/or include other components that are omitted for brevity without departing from this invention.

The processor 510 can include (but is not limited to) a processor, microprocessor, controller, or a combination of processors, microprocessor, and/or controllers that performs instructions stored in the memory 530 to manipulate data stored in the memory. Processor instructions can configure the processor 510 to perform processes in accordance with certain embodiments of the invention. In various embodiments, processor instructions can be stored on a non-transitory machine readable medium.

In a variety of embodiments, network interface 520 can be used to gather inputs and/or provide outputs. Forecast server 500 can utilize network interface 520 to transmit and receive data over a network based upon the instructions performed by processor 510. Network interfaces in accordance with many embodiments of the invention can be used to gather inputs that can be used to standardize.

Memory 530 may include model data 532, and shipment data 534. Shipment data in accordance with a variety of embodiments of the invention can include various types of shipment-related data that can be used in generate shipping profiles for training. In certain embodiments, shipment data can include (but is not limited to) vessel positioning, current event developments, weather alerts, manufacturing ERP data, warehouse ERP data, distribution ERP data, freight carrier tracking, intermodal tracking, terminal tracking and/or any other data that is relevant to shipment of goods.

Although a specific example of a forecast server is illustrated in this figure, any of a variety of forecast servers can be utilized to perform processes for training LLMs for the generating of accurate shipping forecasts similar to those described herein as appropriate to the requirements of specific applications in accordance with embodiments of the invention.

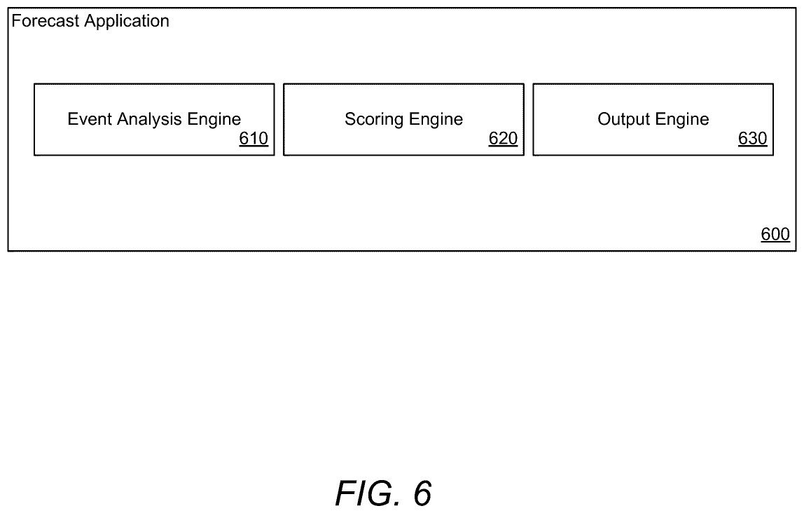

An example of a forecast application for generating forecasts in accordance with an embodiment of the invention is illustrated in FIG. 6. Forecast application 600 includes event analysis engine 610, scoring engine 620, and output engine 630. One skilled in the art will recognize that a forecast application may exclude certain components and/or include other components that are omitted for brevity without departing from this invention.

Event analysis engine 610 in accordance with various embodiments of the invention can be used to analyze events that may affect shipment progress. Event analysis engine 610 can coordinate the various servers to determine whether a particular event could affect shipping progress. In several embodiments, scoring engine 620 can determine a health score for at least one leg of a particular shipment that is in progress. In many embodiments, scoring engine 620 can determine a health score for each leg of a particular shipment that is in progress. Scoring engine 620 may coordinate with event analysis engine 610 and adjust the health score of the leg of shipment that has been deemed to be affected by an event as determined by the event analysis engine 610. Output engines 630 in accordance with several embodiments of the invention can provide a variety of outputs to a user, including (but not limited to) health score of shipments, as well as shipment progress forecasts for at least one leg of the shipment. In some embodiments, users can make changes to the arrangements for particular legs of shipments based on the health score of the progress of the shipment.

Although a specific example of a forecast application is illustrated in this figure, any of a variety of forecast applications can be utilized to perform processes for forecasting shipment progress similar to those described herein as appropriate to the requirements of specific applications in accordance with embodiments of the invention.

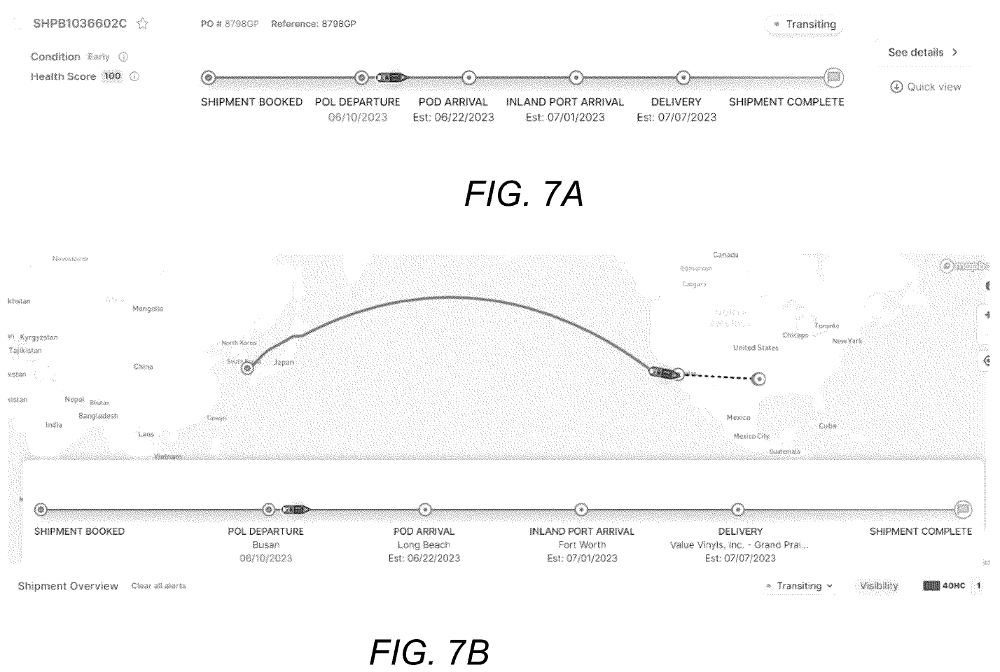

A generated shipping forecast in accordance with an embodiment of the invention is illustrated in FIGS. 7A and 7B. FIG. 7A displays the generated forecasts for a shipment as a timeline where an estimated date is generated for each step of the shipment. FIG. 7B incorporates a map displaying the geographical locations of the shipment corresponding to the generated shipping forecasts.

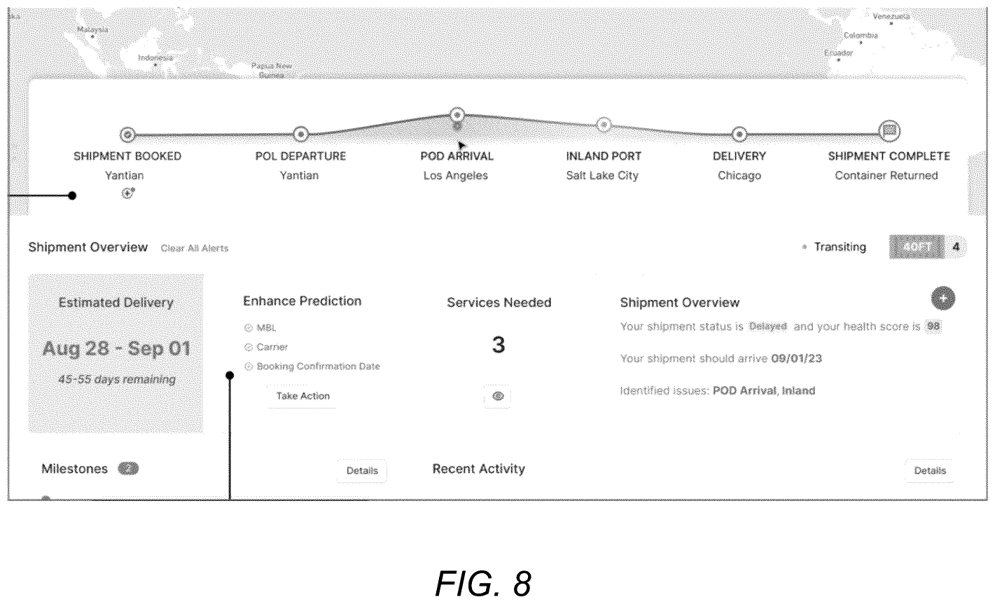

A user interface for generating shipping forecasts in accordance with an embodiment of the invention is illustrated in FIG. 8. Trained LLMs in accordance with many embodiments can generate a health score as part of the shipment forecast. The health score of shipments may be affected by events including but not limited to weather and issues with shipping vessels. As shipment data related to a shipment changes, the LLM can generate a new shipment profile with an accompanying shipment progress date sequence. Based upon the new shipment progress date sequence, the forecast server can generate a health score for the shipment based on the difference between the newly generated shipment progress date sequence and a previously generated shipment progress date sequence that was utilized to provide an initial forecast of a shipment arrival date. A health score may be generated for each leg of a particular shipment. By receiving input from a user device and/or mobile device, a system in accordance with various embodiments of the invention can provide for the adjustment of shipping methods for each and every leg of a particular shipment based on the generated health score in an attempt to address any delays that may result.

In many embodiments, the system is able to track and present the progress of multiple shipments as individual timelines on an interactive UI. The UI can present multiple views of a single shipment out of the multiple shipments that the system tracks and is able to present different pieces of information regarding the shipment that can help users make critical decisions in freight management. The UI can present the shipment progress as both a timeline and a map that displays the progress of the shipment geographically. The UI can display a forecast of all legs of the shipment based on a synthesis of multiple sources of data, including but not limited to weather conditions of the vessel, geographic locations of the vessel, bills of lading (BOL), voyage specifics, visited ports, vessel capacity, and details sourced from Packing Lists (PL), ERP systems, freight management software, manual data entries, and custom-house data. If any leg of a shipment encounters circumstances that reflect a change in the data used to synthesize the forecasts such that the forecast model determines a high likelihood of delay in its progress, the health score of the particular leg of the shipment decreases, and the UI can present the drop in health score in a manner where only the portions of the shipment's timeline that may be delayed is highlighted such that the user can quickly understand the source of the delay. Further, the UI provides the ability for the user to make adjustments to the shipping method based on the timeline.

Although specific methods of training large language models for generating accurate shipping forecasts are discussed above, many different methods of training can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for training a large language model to generate accurate shipping forecasts comprising:
receiving input data comprising a plurality of categories of shipment data, wherein the shipment data comprises a shipment progress date sequence;
standardizing each of the plurality of categories of shipment data;
generating a plurality of shipping profiles based on the standardized shipment data; and
training a large language model to generate a new shipping profile, wherein the new shipping profile comprises a predicted shipment progress date sequence associated with an upcoming shipment.

2. The method of claim 1, wherein the plurality of categories of shipment data comprises at least one source of shipment data selected from the group consisting of: freight logistic data, importer supply chain data, and external factor data.

3. The method of claim 2, wherein the freight logistic data comprises at least one source of freight logistic data selected from the group consisting of: vessel traffic data, vessel schedules, ocean carrier service itineraries, lists of actively registered International Maritime Organization (IMO) vessels, and ocean container vessel data.

4. The method of claim 2, wherein the external factor data comprises at least one source of external factor data selected from the group consisting of: inclement weather conditions, port congestion conditions, and current market conditions.

5. The method of claim 2, wherein the importer supply chain data comprises at least one source of importer supply chain data selected from the group consisting of: Packing Lists (PL), enterprise resource planning (ERP) systems, freight management software, manual data entries, and custom-house data.

6. The method of claim 1, wherein the large language model is trained using a training corpus comprising a data frame built by combining freight logistic data, importer supply chain data, external factor data, and shipment outcomes.

7. The method of claim 1, wherein the input data comprises Master Bill of Lading (MBL) numbers identifying a cargo booking.

8. The method of claim 1, wherein input data is processed using optical character recognition to extract text from the input data.

9. The method of claim 1, wherein the new shipping profile is adjusted by the large language model when the actual shipping progress deviates from the predicted shipping progress.

10. A non-transitory machine readable medium containing processor instructions for training a large language model to generate accurate shipping forecasts, where execution of the instructions by a processor causes the processor to perform a process that comprises:
receiving input data comprising a plurality of categories of shipment data, wherein the shipment data comprises a shipment progress date sequence;
standardizing each of the plurality of categories of shipment data;
generating a plurality of shipping profiles based on the standardized shipment data; and
training a large language model to generate a new shipping profile, wherein the new shipping profile comprises a predicted shipment progress date sequence associated with an upcoming shipment.

11. The non-transitory machine-readable medium of claim 10, wherein the plurality of categories of shipment data comprises at least one source of shipment data selected from the group consisting of: freight logistic data, importer supply chain data, and external factor data.

12. The non-transitory machine-readable medium of claim 11, wherein the freight logistic data comprises at least one source of shipment data selected from the group consisting of: vessel traffic data, vessel schedules, ocean carrier service itineraries, lists of actively registered International Maritime Organization (IMO) vessels, and ocean container vessel data.

13. The non-transitory machine-readable medium of claim 11, wherein the external factor data comprises at least one source of shipment data selected from the group consisting of: inclement weather conditions, port congestion conditions, and current market conditions.

14. The non-transitory machine-readable medium of claim 11, wherein the importer supply chain data comprises at least one source of shipment data selected from the group consisting of: Packing Lists (PL), enterprise resource planning (ERP) systems, freight management software, manual data entries, and custom-house data.

15. The non-transitory machine-readable medium of claim 10, wherein the large language model is trained using a training corpus comprising a data frame built by combining freight logistic data, importer supply chain data, external factor data, and shipment outcomes.

16. The non-transitory machine-readable medium of claim 10, wherein the input data comprises Master Bill of Lading (MBL) numbers identifying a cargo booking.

17. The non-transitory machine-readable medium of claim 10, wherein input data is processed using optical character recognition to extract text from the input data.

18. The non-transitory machine-readable medium of claim 10, wherein the new shipping profile is adjusted by the large language model when the actual shipping progress deviates from the predicted shipping progress.
